(19) United States
(12) Patent Application Publication
(10) Pub. No.: US 2019/0294706 A1
(43) Pub. Date: Sep. 26, 2019

(54) METHOD TO REDUCE ONLINE IMPACT WHEN UNLOADING A DATABASE

(71) Applicant: CA, Inc., New York, NY (US)

(72) Inventor: Philippe Dubost, Prague (CR)

(21) Appl. No.: 15/928,403

(22) Filed: Mar. 22, 2018

(51) Int. Cl. G06F 17/30; G06F 9/445

(52) U.S. Cl. CPC G06F 17/30289; G06F 9/44594; G06F 17/30368; G06F 17/30377; G06F 17/30374

(57) ABSTRACT

Embodiments of the present disclosure relate to reducing online impact when unloading a database. Initially, a command to unload a database is received. If a last unload file for the database exists, it is detected if data corresponding to the database has been updated since a time corresponding to a last unload timestamp for the last unload file. Based on the detecting, an unload corresponding to the unload command is skipped for the database and machine resources are preserved. If the last unload file for the database has not been altered since the last unload timestamp, an alias is created that points to the last unload file of the database. If the last unload file has been altered or data corresponding to the database has been updated since the last unload timestamp, the database can be unloaded from the last full image copy. In each case, the database remains online.

### BACKGROUND

Database management systems, such as IBM DB2, typically contain business critical data that requires high availability. This can be particularly challenging given the continuously increasing transaction rates. One of the primary factors that affects data availability is the necessity to perform database maintenance tasks. Some of these tasks include database reorganization (to optimize response time of the queries), database backups (to create copies of the data in the event of a disaster recovery situation), and data extraction (to create unload file(s) typically used for post-processing).

While mechanisms exist to reduce outages during such maintenance tasks (typically referred to as “online solutions” (e.g., online reorganization, online copy, online unload)), there is always some sort of outage (e.g., database outage, application outage). Additionally, performing such maintenance tasks requires machine resources, which impacts the overall cost to utilize the underlying systems.

### SUMMARY

This summary is provided to introduce a selection of concepts in a simplified form that are further described below in the detailed description. This summary is not intended to identify key features or essential features of the claimed subject matter, nor should it be used as an aid in determining the scope of the claimed subject matter.

Embodiments of the present disclosure relate to database management systems. More particularly, embodiments of the present disclosure relate to reducing online impact when unloading a database. Initially, a command to unload a database is received. If a last unload file for the database exists, it is detected if data corresponding to the database has been updated since a time corresponding to a last unload timestamp for the last unload file. Based on the detecting, an unload corresponding to the unload command can be skipped for the database and machine resources are preserved. For example, if the last unload file for the database has not been altered since the last unload timestamp, an alias is created that points to the last unload file of the database. On the other hand, if it is detected that data corresponding to the database has been updated or the last unload file of the database has been altered since a time corresponding to the last unload timestamp, then it is determined whether a last full image copy of the database exists. If data corresponding to the database has not been updated since a last full image copy timestamp of the last full image copy, the database can be unloaded from the last full image copy. In each case, the database remains online.

### BRIEF DESCRIPTION OF THE DRAWINGS

The present invention is described in detail below with reference to the attached drawing figures, wherein:

FIG. 1 is a block diagram showing a system that reduces online impact when unloading a database, in accordance with an embodiment of the present disclosure;

FIG. 2 is an exemplary illustration of reducing online impact when unloading a database utilizing an alias, in accordance with embodiments of the present disclosure;

FIG. 3 is an exemplary illustration of reducing online impact when unloading a database utilizing a full image copy, in accordance with embodiments of the present disclosure;

FIG. 4 is a flow diagram showing a method of reducing online impact when unloading a database, in accordance with embodiments of the present disclosure;

FIG. 5 is a flow diagram showing a method of reducing online impact when unloading a database, in accordance with embodiments of the present disclosure;

FIG. 6 is a flow diagram showing a method of reducing online impact when unloading a database utilizing a full image copy, in accordance with embodiments of the present disclosure; and

FIG. 7 is a block diagram of an exemplary computing environment suitable for use in implementing embodiments of the present disclosure.

### DETAILED DESCRIPTION

The subject matter of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. As used herein, the singular forms “a,” “an,” and “the” are intended to include the plural forms as well, unless the context clearly indicates otherwise.

As noted in the background, database management systems, such as IBM DB2, typically contain business critical data that requires high availability. This can be particularly challenging given the continuously increasing transaction rates. One of the primary factors that affects data availability is the necessity to perform database maintenance tasks. Some of these tasks include database reorganization (to optimize response time of the queries), database backups (to create copies of the data in the event of a disaster recovery situation), and data extraction (to create unload file(s) typically used for post-processing).

While mechanisms exist to reduce outages during such maintenance tasks (typically referred to as “online solutions” (e.g., online reorganization, online copy, online unload)), there is always some sort of outage (e.g., database outage, application outage). Additionally, performing such maintenance tasks requires machine resources, which impacts the overall cost to utilize the underlying systems.

Embodiments of the present disclosure reduce online impact when unloading a database. Initially, a command to unload a database is received. If a last unload file for the database already exists, it is detected if data corresponding to the database has been updated since a time corresponding to a last unload timestamp for the last unload file. Based on the detecting, an unload corresponding to the unload command can be skipped for the database and machine resources are preserved. For example, if the last unload file for the database has not been altered since the last unload timestamp, an alias is created that points to the last unload file of the database. On the other hand, if it is detected that data corresponding to the database has been updated or the last unload file of the database has been altered since a time corresponding to the last unload timestamp, then it is determined whether a last full image copy of the database exists. If data corresponding to the database has not been updated since a last full image copy timestamp of the last full image copy, the database can be unloaded from the last full image copy. In each case, the database remains online (i.e., high-availability of the database is insured and no outage is necessary for the unload).

In some embodiments, when regularly extracting data from a read-only table, the resulting unload file typically the same data as the previous extraction. Accordingly, the normal extraction process can be avoided by detecting whether or not the data in a table has been updated since the last extraction timestamp. In this case, the unload file from a previous extraction is verified that it has not be altered by some processing since the previous extraction. In some embodiments, an alias (i.e., a shortcut) can be created with proper naming convention to point to the last unload file.

In some embodiments, data extraction directly from the table can be avoided in circumstances when regular backups are taken (e.g., consistent full image copies) and the data in the table has not been updated since the last full image copy. In this case, an unload can be performed from the full image copy (i.e., offline processing) and outages implied by the data extraction directly from the table are avoided.

Accordingly, one embodiment of the present disclosure is directed to a method. The method comprises receiving an unload command for a database. The method also comprises determining a last unload file of a database exists. The last unload file has a last unload timestamp. The method further comprises detecting if data corresponding to the database has been updated since a time corresponding to the last unload timestamp. The method also comprises based on the detecting, skipping an unload corresponding to the unload command for the database. Throughout the method, the database remains online.

In another embodiment, the present disclosure is directed to a computer storage medium storing computer-useable instructions that, when used by at least one computing device, cause the at least one computing device to perform operations. The operations comprise receiving an unload command for a database. The operations also comprise determining a last full image copy of the database exists. The last full image copy has a last full image copy timestamp. The operations further comprise detecting data for the database has not been updated since the last full image copy timestamp. The operations also comprise based on the detecting, skipping an unload corresponding to the unload command for the database. The operations further comprise unloading the database from the last full image copy. Throughout the operations, the database remains online.

In yet another embodiment, the present disclosure is directed to a computerized system. The system includes a processor and a computer storage medium storing computer-useable instructions that, when used by the processor, cause the processor to receive an unload command for a database. A last unload file of a database is determined to exist. The last unload file has a last unload timestamp. It is detected if data corresponding to the database has been updated since a time corresponding to the last unload timestamp. Based on the detecting, an unload corresponding to the unload command is skipped for the database. The database remains online.

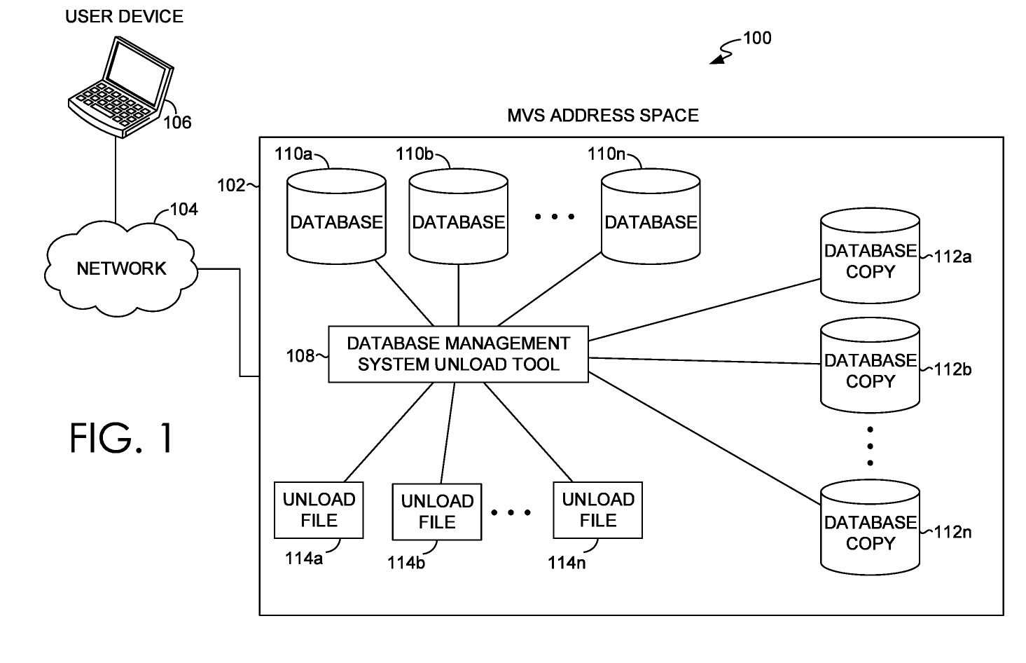

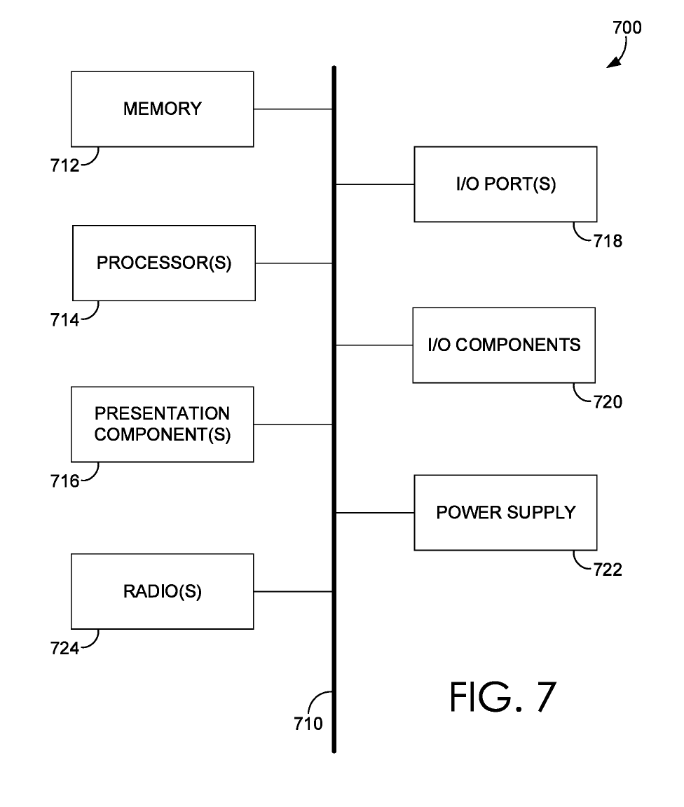

Referring now to FIG. 1, a block diagram is provided that illustrates an unload system 100 that reduces online impact when unloading a database, in accordance with an embodiment of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory. The unload system 100 may be implemented via any type of computing device, such as computing device 700 described below with reference to FIG. 7, for example. In various embodiments, the unload system 100 may be implemented via a single device or multiple devices cooperating in a distributed environment.

As noted, the unload system 100 generally operates to reduce online impact when unloading a database. As shown in FIG. 1, the unload system 100 may include a mainframe environment and includes, among other components, in Multiple Virtual Storage (MVS) address space 102, database management system (DBMS) unload tool 108 (which may be part of a DBMS), databases 110a-110n, database copies 112a-112n, and unload files 114a-114n. The unload system may also include user device 106. It should be understood that the unload system 100 shown in FIG. 1 is an example of one suitable computing system architecture. Each of the components shown in FIG. 1 may be implemented via any type of computing device, such as computing device 700 described with reference to FIG. 7, for example.

The components may communicate with each other via a network 104, which may include, without limitation, one or more local area networks (LANs) and/or wide area networks (WANs). Such networking environments are commonplace in offices, enterprise-wide computer networks, intranets, and the Internet. It should be understood that any number of user devices, DBMSs, DBMS unload tools, databases, database copies, and unload files may be employed by the unload system 100 within the scope of the present disclosure. Each may comprise a single device or multiple devices cooperating in a distributed environment. For instance, the unload system 100 may be provided via multiple devices arranged in a distributed environment that collectively provide the functionality described herein. Additionally, other components not shown may also be included within the network environment.

User device 106 may be any type of computing device used to interact with database 110a-110n, DBMS, or DBMS unload tool 108. User device 104 may be capable of communicating via the network 202 with DBMS, database management system (DBMS) unload tool 108, and/or databases 110a-110n. Such a device may include any type of mobile and portable devices including cellular telephones, personal digital assistants, tablet PCs, smart phones, and the like.

As mentioned previously, the DBMS unload tool 108 may be part of a DBMS (not shown in FIG. 1). In some embodiments, the DBMS tool 108 may be a standalone tool apart from the DBMS and may reside in MVS address space 102, as a cloud service, or provided via the user device 106. The DBMS unload tool 108 generally reduces online impact when unloading a database. To do so, the DBMS unload tool 108 relies on an ability to detect if data in a table was modified between different points in times (i.e., since the last full image copy, or since the last unload or data extraction). In various embodiments, the DBMS unload tool detects if data was modified between different points in time by retrieving this information from log scanning analysis (e.g., SYSLOG range system tables in DB2) or the operating system. In embodiments, the timestamp is created by a copy utility or an unload utility which is stored and accessed by or via the DBMS.

Each database 110a-110n generally consists of a group of tables. Some tables may be frequently updated (i.e., the data is modified) by users or applications. For example, users or applications may perform operations such as INSERT, UPDATE, MERGE, or DELETE to update the tables. Some tables may be updated less frequently and some tables may be updated rarely, or never at all. For example, in an Enterprise Resource Planning (ERP) system (e.g., SAP ERP), thousands of database tables are relied on to streamline processes and information across an organization. However, a large portion of these database tables is read-only. Accordingly, these database tables are only updated occasionally.

Database copies (i.e., full image copies) 112a-112n generally contains all of the data of a tablespace, indexspace, or partition that is copied from one or more tables of database(s) 110a-110n. Database copies 112a-112n may be utilized to recover data. Each database copy may include a timestamp that identifies the date and time the full image copy was created from the database(s) 110a-110n.

In various embodiments, the timestamp is provided by the DBMS, the DBMS unload tool 108, and/or the operating system. As can be appreciated, the primary purpose of a full image copy is to recover data, if necessary. In order for a recover job to work (e.g., a point-in-time recovery), the DBMS must be aware of when the copy was created. Thus, a last full image copy timestamp is accessible to the DBMS so a copy can be properly used to recover data. In some embodiments the timestamp is stored by the copy utility in a system table (e.g., SYSCOPY in DB2).

Unload files 114a-114n generally represent data that has been extracted from one or more tables of database(s) 110a-110n. Unload files 114a-114n may correspond to a subset of data. For example, an unload command may be executed via the DBMS from a table for a particular time period. Rather than extracting all available data from the table, the DBMS only extracts the portion of data from the table that falls within the particular time period. Unload files 114a-114n may be utilized by a user or application for additional processing. This additional processing may or may not alter the unload files 114a-114n. Each unload file may include a timestamp that identifies the date and time the data was extracted from the database(s) 110a-110n.

In various embodiments, the timestamp is provided by the DBMS, the DBMS unload tool 108, and/or the operating system. For example, the last unload timestamp may be stored in a utility execution table or a utility history table. In another example, the last unload timestamp may be stored in a proprietary table utilized by the unload utility.

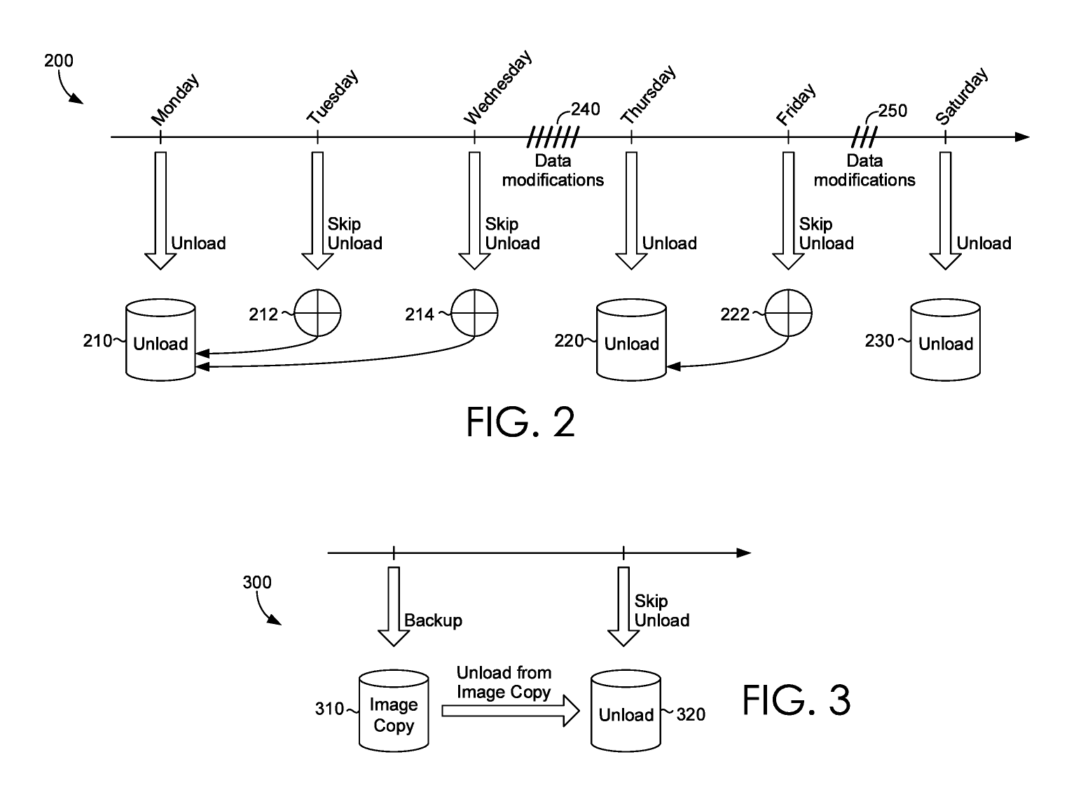

In practice, and as illustrated by FIGS. 2 and 3, the online impact when unloading a database is reduced by utilizing an unload system (such as the unload system 100 of FIG. 1). Referring now to FIG. 2, an exemplary illustration of reducing online impact when unloading a database utilizing an alias, in accordance with embodiments of the present disclosure is provided.

As illustrated, an unload command is received by an unload system for a database. Initially, the unload system determines if a last unload file exists for the database. In this example, no previous unload file has been created. So the unload command is executed by the unload system and an unload file 210 is created. As described, the unload file 210 includes a timestamp.

On Tuesday, a second unload command is received by the unload system for the same database. This time, the unload system determines that the last unload file exists (e.g., Monday unload file 210). Accordingly, the last unload timestamp is the timestamp of the Monday unload file 210. Next, the unload system detects if data corresponding to the database has been updated since the time corresponding to the last unload timestamp. To do so, the unload system may compare edit dates corresponding to the particular database and the last unload timestamp. If the data corresponding to the database has not been updated since the time corresponding to the last unload timestamp (and the last unload file has not been altered by processing since the last unload timestamp), the second unload command for the database can be skipped and the database remains online. An alias or shortcut 212 can be created by the unload system that includes the expected naming convention for an unload file created on Tuesday; however, the alias or shortcut 212 points to the Monday unload file 212.

On Wednesday, a third unload command is received by the unload system for the same database. Again, the unload system determines that the last unload file exists (e.g., the Tuesday alias or shortcut 212 that points to the Monday unload file 210 or the Monday unload file 210 itself). Accordingly, the last unload timestamp is the timestamp of the Tuesday alias or shortcut 212 that points to the Monday unload file 210 or the Monday unload file 210 itself. Next, the unload system detects if data corresponding to the database has been updated since the time corresponding to the last unload timestamp. Again, the unload system may compare edit dates corresponding to the particular database and the last unload timestamp. If the data corresponding to the database has not been updated since the time corresponding to the last unload timestamp (and the last unload file has not been altered by processing since the last unload timestamp), the third unload command for the database can be skipped and the database remains online. An alias or shortcut 214 can be created by the unload system that includes the expected naming convention for an unload file created on Wednesday; however, the alias or shortcut 214 points to the Monday unload file 210.

On Thursday, a fourth unload command is received by the unload system for the same database. Again, the unload system determines that the last unload file exists (e.g., the Wednesday alias or shortcut 214 that points to the Monday unload file 210 or the Monday unload file 210 itself). Accordingly, the last unload timestamp is the timestamp of the Wednesday alias or shortcut 214 that points to the Monday unload file 210 or the Monday unload file 210 itself. Next, the unload system detects if data corresponding to the database has been updated since the time corresponding to the last unload timestamp. Again, the unload system may compare edit dates corresponding to the particular database and the last unload timestamp. This time, the unload system determines the particular database has data modifications 240 because the database has been edited since the last unload timestamp (or the last unload file has been altered by processing since the last unload timestamp). As a result, the unload system executes the fourth unload command and an unload file 220 is created.

On Friday, a fifth unload command is received by the unload system for the same database. Now, the unload system determines that the last unload file exists (e.g., Thursday unload file 220). Accordingly, the last unload timestamp is the timestamp of the Thursday unload file 220. As mentioned, the unload system detects if data corresponding to the database has been updated since the time corresponding to the last unload timestamp. Again, the unload system may compare edit dates corresponding to the particular database and the last unload timestamp. If the data corresponding to the database has not been updated since the time corresponding to the last unload timestamp (or the last unload file has been altered by processing since the last unload timestamp), the fifth unload command for the database can be skipped and the database remains online. An alias or shortcut 222 can be created by the unload system that includes the expected naming convention for an unload file created on Friday; however, the alias or shortcut 222 points to the Thursday unload file 220.

On Saturday, a sixth unload command is received by the unload system for the same database. Again, the unload system determines that the last unload file exists (e.g., the Friday alias or shortcut 222 that points to the Thursday unload file 220 or the Thursday unload file 220 itself). Accordingly, the last unload timestamp is the timestamp of the Friday alias or shortcut 222 that points to the Thursday unload file 220 or the Thursday unload file 220 itself. Next, the unload system detects if data corresponding to the database has been updated since the time corresponding to the last unload timestamp. Again, the unload system may compare edit dates corresponding to the particular database and the last unload timestamp. This time, the unload system determines the particular database has data modifications 250 because the database has been edited since the last unload timestamp (or the last unload file has been altered by processing since the last unload timestamp). As a result, the unload system executes the sixth unload command and an unload file 230 is created.

The exemplary illustration provided by FIG. 2 and described above, preserves resources that would have otherwise been consumed for three of the six unload commands, issued on Tuesday, Wednesday, and Friday. As can be appreciated, when multiple users and multiple applications require extracted data from multiple databases, the cumulative effect of preserving such resources is significant. Additionally, the opportunity to satisfy service level agreements that require a certain percentage of availability of the data (or, put another way, limit outages to a certain percentage of time) is significantly increased. Moreover, costs corresponding to resource usage is greatly reduced.

Turning to FIG. 3, an exemplary illustration of reducing online impact when unloading a database utilizing a full image copy, in accordance with embodiments of the present disclosure is provided. As illustrated, an unload command is received by an unload system for a database. Initially, the unload system may determine if a last unload file exists for the database. In this example, assume no previous unload file has been created or a previous unload file has been created but data corresponding to the database has been updated since the time corresponding to the last unload timestamp or the last unload file has been altered by processing since the last unload timestamp. Rather, than execute the unload command, the unload system determines that a full image copy 310 of the database exists.

The unload system detects if data corresponding to the database has been updated since the time corresponding to the last full image copy timestamp of the fully image copy. To do so, the unload system may compare edit dates corresponding to the particular database and the last full image copy timestamp. If the data corresponding to the database has not been updated since the time corresponding to the last full image copy timestamp, the unload command for the database can be skipped and the database remains online. Instead, the database can be unloaded from the full image copy 310 and an unload file 320 is created even though the unload command was skipped. As mentioned with respect to the description corresponding to FIG. 2, when multiple users and multiple applications require extracted data from multiple databases, the cumulative effect of preserving such resources is significant. Again, the opportunity to satisfy service level agreements that require a certain percentage of availability of the data (or, put another way, limit outages to a certain percentage of time) is significantly increased.

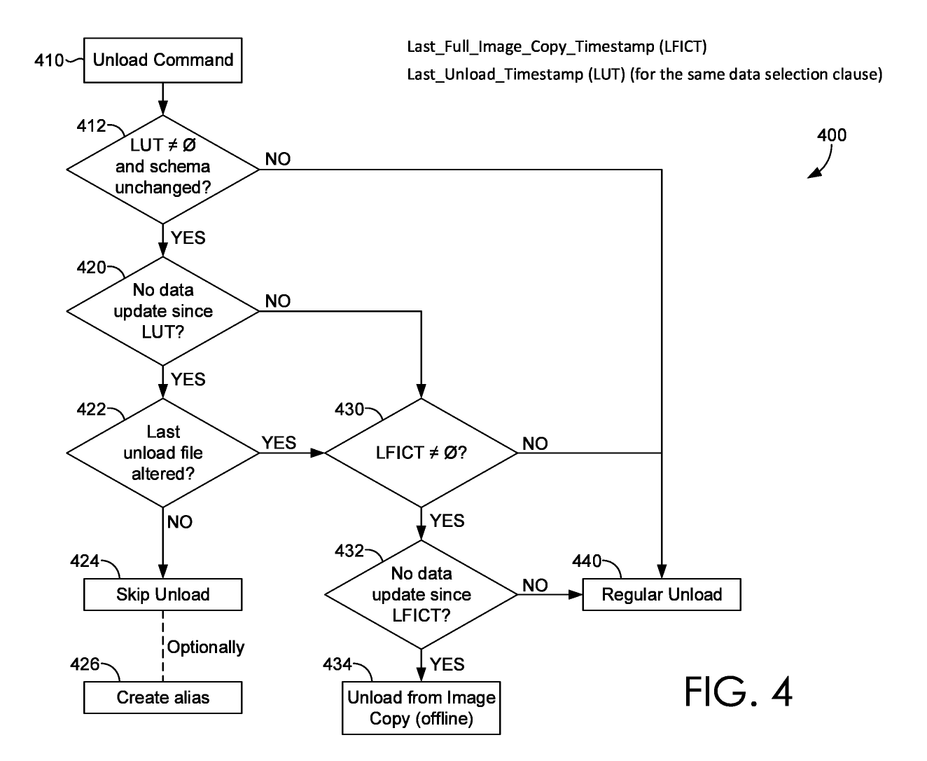

In FIG. 4, a flow diagram is provided that illustrates a method 400 of reducing online impact when unloading a database, in accordance with embodiments of the present disclosure. For instance, the method 400 may be employed utilizing the unload system 100 of FIG. 1. As shown at step 410, an unload command is received by an unload system for a database. Initially, the unload system determines if a last unload file exists for the database. In this example, the unload system may determine whether a last unload file timestamp exists (for the same data corresponding to the unload command), at step 412. The unload system also confirms that the schema for the database has not changed, also at step 412. If the last unload file timestamp does not exist or the schema for the database has changed, the unload system executes the unload command, at step 440.

If the unload system determines the last unload file timestamp exists and the schema for the database has not changed, the unload system determines, at step 420, whether data corresponding to the database has been updated since the last unload file timestamp. If data corresponding to the database has not been updated since the last unload file timestamp, the unload system determines whether the last unload file has been altered, at step 422. If the unload file has not been altered, the unload command is skipped, at step 424. An alias may be created, at step 426, that points to the last unload file corresponding to the last unload file timestamp.

If the unload system determines, at step 420, that data corresponding to the database has been updated since the last unload file timestamp, the unload system determines whether a last full image copy exists (or if a last full image copy timestamp exists), at step 430. If the last full image copy does not exists (or the last full image copy timestamp), the unload command is executed, at step 440. If the last full image copy exists (or if the last full image copy timestamp exists), the unload system determines if data corresponding to the database has been updated since the last full image copy timestamp, at step 432. If data corresponding to the database has been updated since the last full image copy timestamp, the unload command is executed, at step 440. If data corresponding to the database has not been updated since the last full image copy timestamp, the unload command is skipped and the database is unloaded from the last full image copy, at step 434 (and the database remains online).

If the unload system determines that the last unload file has been altered, at step 422, the unload system determines whether a last full image copy exists (or if a last full image copy timestamp exists), at step 430. If the last full image copy does not exists (or the last full image copy timestamp), the unload command is executed, at step 440. If the last full image copy exists (or if the last full image copy timestamp exists), the unload system determines if data corresponding to the database has been updated since the last full image copy timestamp, at step 432. If data corresponding to the database has been updated since the last full image copy timestamp, the unload command is executed, at step 440. If data corresponding to the database has not been updated since the last full image copy timestamp, the unload command is skipped and the database is unloaded from the last full image copy, at step 434 (and the database remains online).

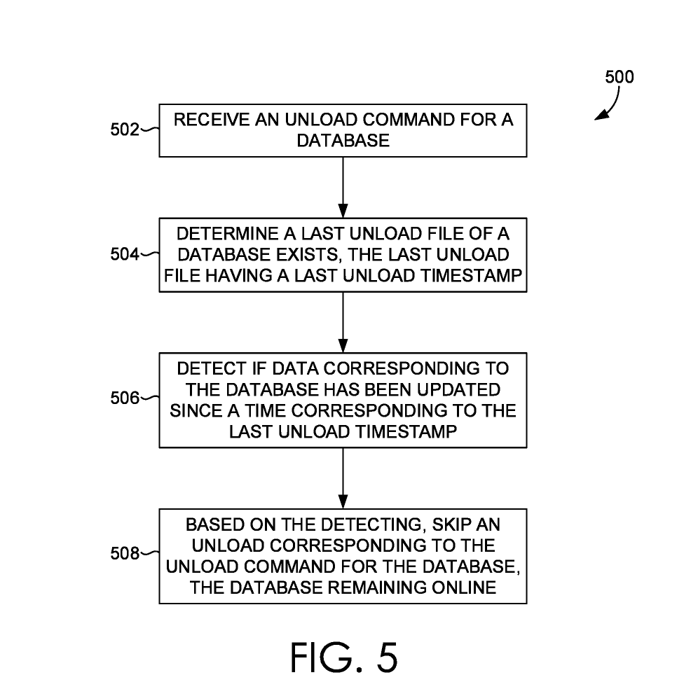

Turning now to FIG. 5, a flow diagram is provided that illustrates a method 500 of reducing online impact when unloading a database, in accordance with embodiments of the present disclosure. For instance, the method 500 may be employed utilizing the unload system 100 of FIG. 1. As shown at step 502, an unload command for a database is received.

At step 504, a last unload file of a database is determined to exist. The last unload file includes a last unload timestamp. It is detected, at step 506, if data corresponding to the database has been updated since a time corresponding to the last unload timestamp. The detecting may comprise performing log scanning or analyzing information from a system table (e.g., a SYSLOG range system table in DB2). Based on the detecting, at step 508, an unload corresponding to the unload command for the database is skipped, and the database remains online.

In some embodiments, it is determined the last unload file for the database has not been altered since the last unload timestamp. In some embodiments, it is also determined that a schema for the database has not been altered since a time corresponding to the last unload timestamp. An alias may be created that points to the last unload file of the database. The database may be a subset of a database (e.g., data corresponding to a particular time period or to particular tables of the database).

In some embodiments, it is determined the last unload file for the database has been altered. In this case, it can be determined whether a last full image copy of the database exists. The last full image copy includes a last full image copy timestamp. If it is detected that data corresponding to the database has not been updated since a time corresponding to the last full image copy timestamp, the database can be unloaded from the offline image copy and the database remains online.

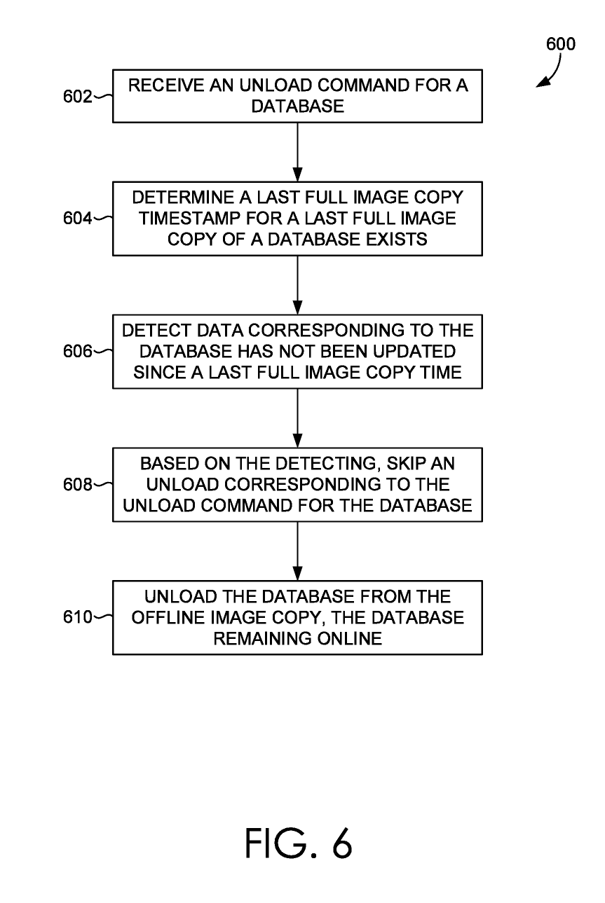

In FIG. 6, a flow diagram is provided that illustrates a method 600 of reducing online impact when unloading a database utilizing a full image copy, in accordance with embodiments of the present disclosure. For instance, the method 600 may be employed utilizing the unload system 100 of FIG. 1. As described above and as shown at step 602, an unload command for a database may be received.

At step 604, a last full image copy of the database is determined to exist. The last full image copy includes a last full image copy timestamp. It is detected, at step 606, that data corresponding to the database has not been updated since the last full image copy timestamp. Based on the detecting, an unload corresponding to the unload command for the database is skipped, at step 608. The database is unloaded, at step 610, from the last full image copy and the database remains online.

Having described embodiments of the present disclosure, an exemplary operating environment in which embodiments of the present disclosure may be implemented is described below in order to provide a general context for various aspects of the present disclosure. Referring to FIG. 7 in particular, an exemplary operating environment for implementing embodiments of the present disclosure is shown and designated generally as computing device 700. Computing device 700 is but one example of a suitable computing environment and is not intended to suggest any limitation as to the scope of use or functionality of the inventive embodiments. Neither should the computing device 700 be interpreted as having any dependency or requirement relating to any one or combination of components illustrated.

The inventive embodiments may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The inventive embodiments may be practiced in a variety of system configurations, including handheld devices, consumer electronics, general-purpose computers, more specialty computing devices, etc. The inventive embodiments may also be practiced in distributed computing environments where tasks are performed by remote-processing devices that are linked through a communications network.

With reference to FIG. 7, computing device 700 includes a bus 710 that directly or indirectly couples the following devices: memory 712, one or more processors 714, one or more presentation components 716, input/output (I/O) ports 718, input/output (I/O) components 720, and an illustrative power supply 722. Bus 710 represents what may be one or more busses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 7 is merely illustrative of an exemplary computing device that can be used in connection with one or more embodiments of the present disclosure. Distinction is not made between such categories as “workstation,” “server,” “laptop,” “handheld device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 712 includes computer-storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc. The I/O components 720 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 700. The computing device 700 may be equipped with depth cameras, such as stereoscopic camera systems, infrared camera systems, RGB camera systems, and combinations of these, for gesture detection and recognition. Additionally, the computing device 700 may be equipped with accelerometers or gyroscopes that enable detection of motion. The output of the accelerometers or gyroscopes may be provided to the display of the computing device 700 to render immersive augmented reality or virtual reality.

As can be understood, embodiments of the present disclosure provide for an objective approach for enabling a JVM to process a data object in common storage. The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A computer-implemented method comprising:
receiving an unload command for a database;
determining a last unload file of a database exists, the last unload file having a last unload timestamp;
detecting if data corresponding to the database has been updated since a time corresponding to the last unload timestamp; and
based on the detecting, skipping an unload corresponding to the unload command for the database, the database remaining online.

2. The method of claim 1, further comprising determining the last unload file for the database has not been altered since the last unload timestamp.

3. The method of claim 1, further comprising creating an alias that points to the last unload file of the database.

4. The method of claim 1, wherein the database is a subset of a database.

5. The method of claim 1, further comprising determining the last unload file for the database has been altered.

6. The method of claim 5, further comprising determining a last full image copy of the database exists, the last full image copy having a last full image copy timestamp.

7. The method of claim 6, further comprising detecting data corresponding to the database has not been updated since a time corresponding to the last full image copy timestamp.

8. The method of claim 7, further comprising unloading the database from the offline image copy, the database remaining online.

9. The method of claim 1, wherein the detecting comprises performing log scanning or analyzing information from a system table.

10. The method of claim 1, further comprising determining a schema for the database has not been altered since a time corresponding to the last unload timestamp.

11. One or more computer storage media having computer-executable instructions embodied thereon that, when executed by a computer, causes the computer to perform operations, the operations comprising:
receiving an unload command for a database;
determining a last full image copy of the database exists, the last full image copy having a last full image copy timestamp;
detecting data corresponding to the database has not been updated since the last full image copy timestamp;
based on the detecting, skipping an unload corresponding to the unload command for the database; and
unloading the database from the last full image copy, the database remaining online.

12. The media of claim 11, further comprising:
determining a last unload file of a database exists, the last unload file having a last unload timestamp; and
detecting data corresponding to the database has been updated since a time corresponding to the last unload timestamp.

13. The media of claim 12, further comprising determining the last unload file for the database has been altered since a time corresponding to the last unload timestamp.

14. The media of claim 11, wherein the detecting comprises log scanning or analyzing information from a system table.

15. The media of claim 11, further comprising determining a schema for the database has not been altered since a time corresponding to the last unload timestamp.

16. The media of claim 11, wherein the database is a subset of a database.

17. The media of claim 11, further comprising skipping an unload corresponding to the unload command for the database, the database remaining online.

18. A computerized system comprising:
a processor; and
a computer storage medium storing computer-useable instructions that, when used
by the processor, causes the processor to:
receive an unload command for a database;
determine a last unload file of a database exists, the last unload file having a last unload timestamp;
detect if data corresponding to the database has been updated since a time corresponding to the last unload timestamp; and
based on the detecting, skip an unload corresponding to the unload command for the database, the database remaining online.

19. The system of claim 18, further comprising:
determining the last unload file for the database has not been altered since the last unload timestamp; and
creating an alias that points to the last unload file of the database.

20. The system of claim 18, further comprising:
detecting data corresponding to the database has been updated or determining the last unload file of the database has been altered since a time corresponding to the last unload timestamp;
determining a last full image copy of the database exists, the last full image copy having a last full image copy timestamp;
detecting data corresponding to the database has not been updated since the last full image copy timestamp; and
unloading the database from the last full image copy, the database remaining online.
